(19) United States
(12) Patent Application Publication
(10) Pub. No.: US 2016/0055646 A1
(43) Pub. Date: Feb. 25, 2016

(54) METHOD FOR ESTIMATING THE ANGULAR DEVIATION OF A MOBILE ELEMENT RELATIVE TO A REFERENCE DIRECTION

(71) Applicants: ALDEBARAN ROBOTICS, Paris (FR); ASSOCIATION POUR LA RECHERCHE ET LE DEVELOPPEMENT DE MÉTHODES ET PROCESSUS INDUSTRIELS - ARMINES, Paris (FR)

(72) Inventors: Emilie WIRBEL, PARIS (FR); Franck DURIEZ, SAINT-MICHEL-SUR-ORGE (FR); Arnaud DE LA FORTELLE, PARIS (FR); Bruno STEUX, CHATOU (FR); Silvère BONNABEL, BOULOGNE BILLANCOURT (FR)

(21) Appl. No.: 14/783,410

(22) PCT Filed: Apr. 9, 2014
(86) PCT No.: PCT/EP2014/057135

§ 371 Date: Oct. 8, 2015

(30) Foreign Application Priority Data
Apr. 11, 2013 (FR) 1353295

(51) Int. Cl. G06T 7/20; G06K 9/62; G06T 7/00

(52) U.S. Cl. CPC G06T 7/20; G06T 7/0044; G06K 9/6202; G06T 2207/30241

(57) ABSTRACT

A method for estimating the angular deviation of a moving element relative to a reference direction comprises the following steps: acquisition of a reference image of a reference direction of the moving element; acquisition of a current image of the current direction of the moving element; identification of points of interest in the reference image and in the current image; determination of at least two pairs of points of interest, one pair being made up of a point of interest in the current image and of a point of interest corresponding thereto in the reference image; determination of the angular deviation between the current direction and the reference direction of the moving element by using the at least two pairs of points identified in the preceding step.

The invention concerns a method for estimating the angular deviation of a moving element relative to a reference direction and can be applied notably to the field of navigation.

In order to estimate the course of a moving element such as a robot, a first technique consists in using its odometry, that is to say using the measurement of its movement. For that purpose, measurements from various onboard sensors can be used. Thus, for a wheeled robot, it is possible to use odometers of rotary encoder type that are situated in the wheels. One of the disadvantages of this technique is that it produces an estimation that drifts significantly over time.

A second technique that exists consists in implementing metric sensors such as a laser telemeter or a 3D camera in order to obtain one's bearings in relation to a map representing a navigation environment. The methods that rely on this technique are denoted by the acronym SLAM (Simultaneous Localization And Mapping), the map in this case being likewise constructed and enriched during the navigation of the robot. This solution has several disadvantages. This is because it is necessary to integrate these sensors into the architecture of the robot. This involves high implementation costs and requires significant computation power in order to generate a map and determine the position of the robot.

A third technique that exists is based on the use of a six-axis inertial unit. This inertial unit is usually made up of three gyroscopes and three accelerometers and can notably provide the course of the robot. Such units are likewise subject to a measurement drift phenomenon or else are very expensive. This technique is therefore not suited to implementation in a robot with low implementation cost.

Thus, it appears that robot designers have no technique available that allows them to obtain a precise course estimation while minimizing implementation costs.

It is notably an aim of the invention to compensate for the aforementioned disadvantages.

To this end, the subject of the invention is a method for estimating the angular deviation of a moving element relative to a reference direction, the method comprising the following steps: acquisition of a reference image that is representative of a reference direction of the moving element; acquisition of a current image that is representative of the current direction of the moving element; identification of points of interest in the reference image and in the current image; determination of at least two pairs of points of interest, one pair being made up of a point of interest identified in the current image and of a point of interest corresponding thereto in the reference image; determination of the angular deviation between the current direction and the reference direction of the moving element by using the at least two pairs of points identified in the preceding step.

The use of the method for estimating the angular deviation of a robot relative to a reference direction makes it possible to avoid the estimation errors that are characteristic of odometry.

According to one aspect of the invention, the points of interest are associated with descriptors corresponding to binary vectors, the step of determination of the pairs being implemented by means of comparison of these vectors in twos, a couple of points of interest being identified when the two vectors of two points of interest are considered to be closest in relation to other candidate vectors associated with other points of interest.

By way of example, the angular deviation is determined along the three axes X, Y, Z of an orthonormal reference frame that is fixed in relation to the moving element.

In one embodiment, the method comprises a step of verification of the quality of the estimation of the angular deviation, the quality being considered sufficient when the number of pairs of matched points of interest exceeds a predefined threshold value.

According to one aspect of the invention, a new reference image is acquired when the quality is considered insufficient.

Advantageously, this quality control makes it possible to keep an estimation of the reliable angular deviation while the moving element moves.

By way of example, the refresh rate of the reference image is adapted according to the quality of the points of interest, said quality being estimated from the level of correct points of interest and the reference image being updated as soon as this level is below a predefined threshold value.

By way of example, the refresh rate of the current image is adapted according to the estimated mean distance between the points of interest identified in the current image, the refresh rate being increased when the points of interest approach one another.

By way of example, the reference direction corresponds to a target course that the moving element needs to follow in order to move, commands for controlling the movement of the moving element being determined and applied so as to minimize the angular deviation estimated by the method.

By way of example, the reference image is chosen so that it remains at least partially in the field of vision of a sensor responsible for acquiring the current image so that a predefined minimum number of points of interest can be matched.

In one embodiment, the initially estimated angular deviation is a radians in relation to a target course that the moving element needs to follow in order to move. The reference direction then corresponds to the target course to which an angular deviation of −α/2 radians is added, commands for controlling the movement of the moving element being determined and applied so that the angular deviation estimated subsequently is as close as possible to +α/2 radians.

According to one aspect of the invention, the reference image is obtained by an image sensor that is onboard the moving element and directed in the reference direction at the moment of the shot.

The subject of the invention is also a method for estimating the angular position of a moving element in a point of reference that is fixed in relation to a navigation space, the method comprising the following steps: acquisition of a panorama that is made up of a plurality of images covering the navigation space, one image of the panorama being representative of a direction leaving the moving element; estimation of the angular position of the moving object by odometry; selection of a reference image from the images of the panorama, said image corresponding to the angular position estimated in the preceding step; refined estimation of the angular position of the moving element, said angular position being deduced from an angular drift estimated by application of the method for estimating the angular deviation.

By way of example, the moving element is a robot. This robot may be of humanoid type.

Alternatively, the moving element may be an automobile.

The subject of the invention is also a humanoid robot comprising means adapted to implementing the method described above.

The subject of the invention is also a computer program having instructions for executing the method described above when the program is executed by a data processing module.

Other features and advantages of the invention will emerge with the aid of the description that follows, which is provided by way of illustration and without implying limitation, and which is written with regard to the appended drawings, among which:

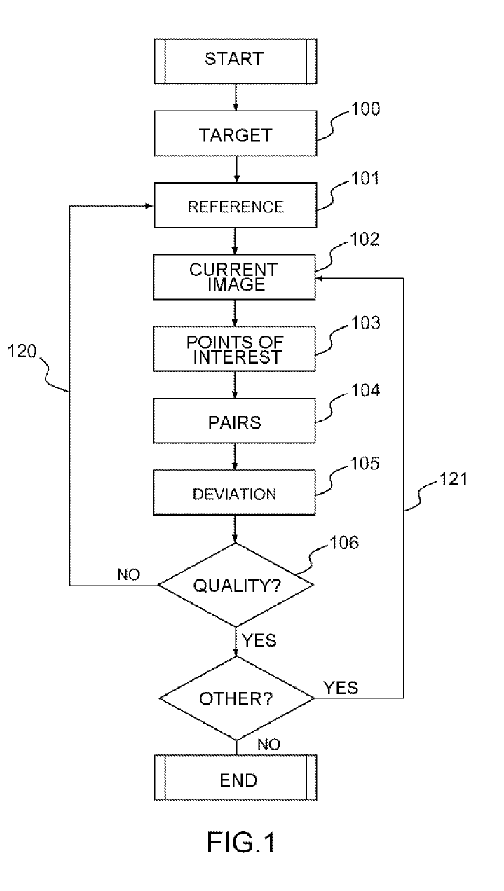

FIG. 1 schematically illustrates the method the steps of a method for estimating angular deviation relative to a reference direction, said reference direction being associated with a reference image, which is called the reference image in the remainder of the description;

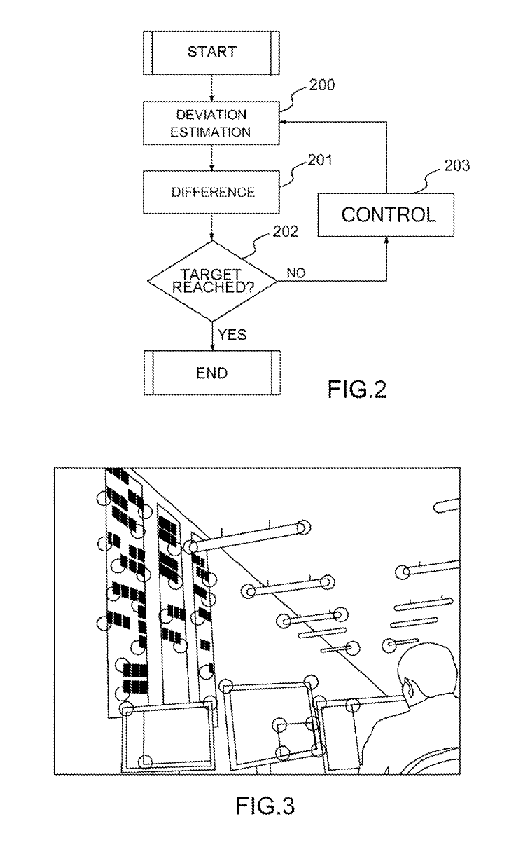

FIG. 2 provides a technical example of control of the trajectory of a robot using the method for estimating the angular drift;

FIG. 3 provides an example of an image in which points of interest have been detected;

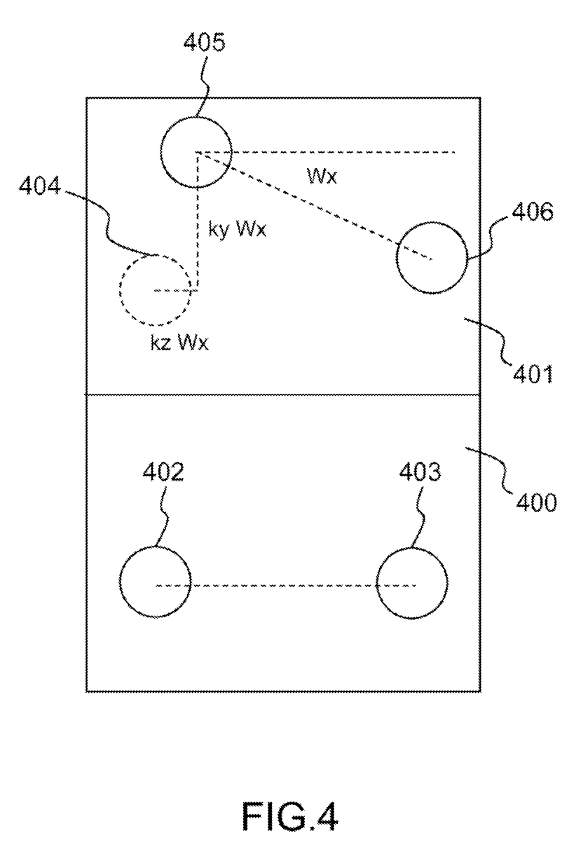

FIG. 4 shows a pair of matched points and illustrates the way in which an angular deviation can be determined from two images;

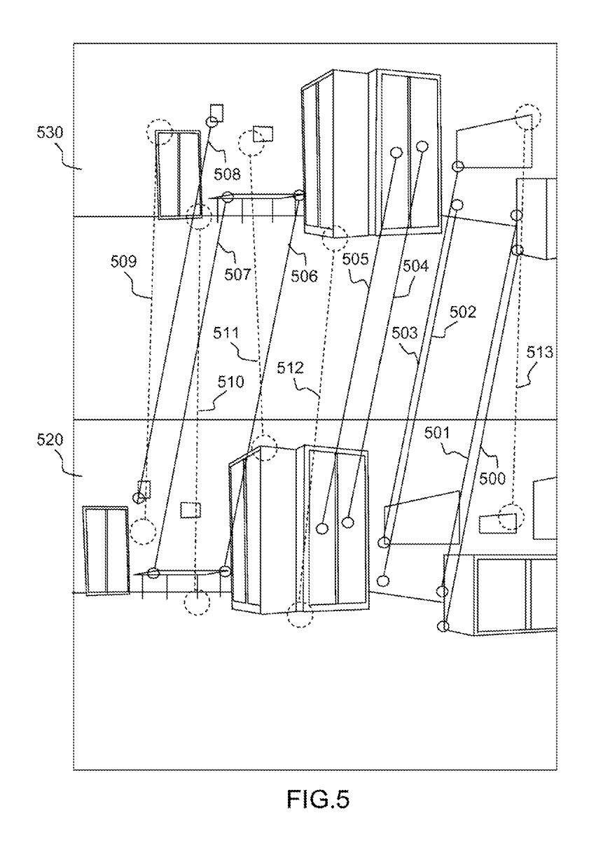

FIG. 5 provides an example of a result that can be obtained by applying a technique for identifying coherent pairs such as RANSAC;

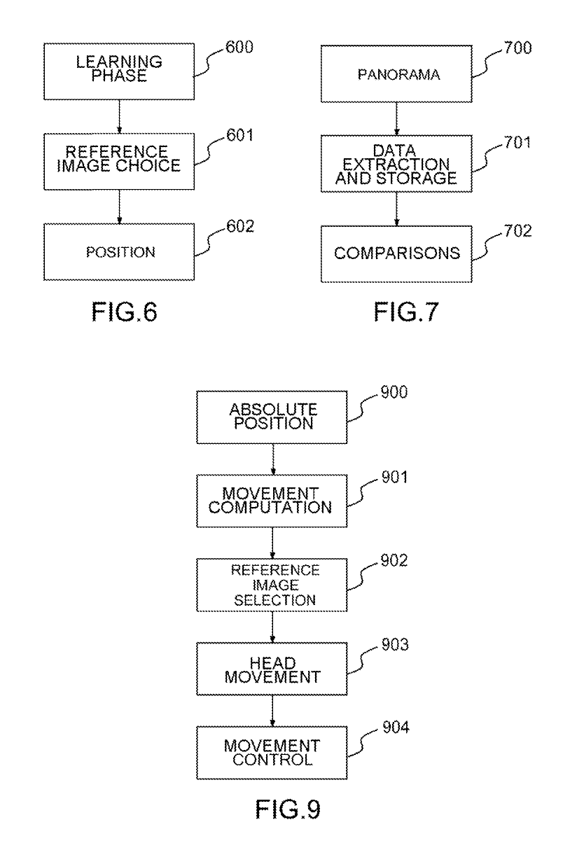

FIG. 6 provides a simplified illustration of a method for estimating the absolute angular position of a moving element;

FIG. 7 schematically illustrates the learning phase of the method for estimating the absolute angular position;

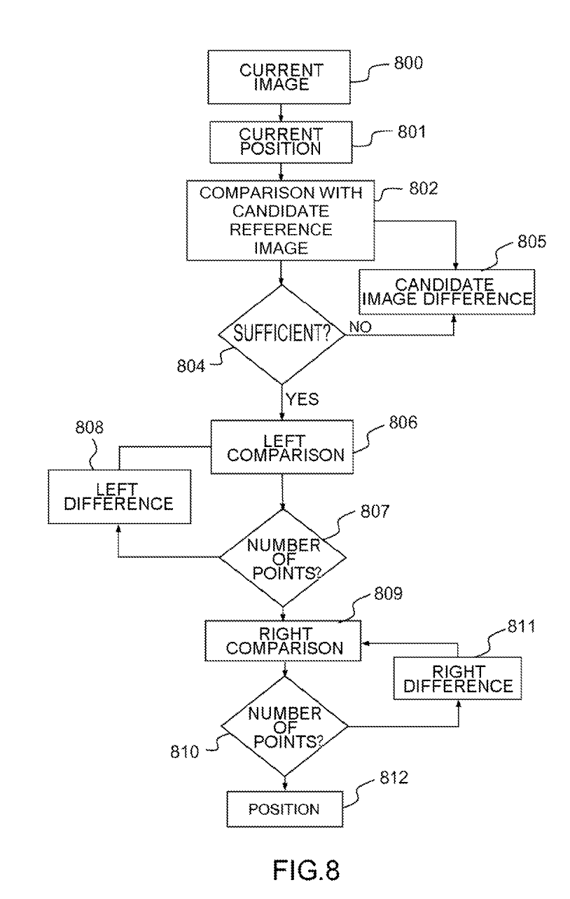

FIG. 8 illustrates a way of choosing a reference image in a panorama and how the absolute angular position of the robot can be estimated;

FIG. 9 illustrates a way of controlling the rotational movements of the robot using an estimation of absolute angular position;

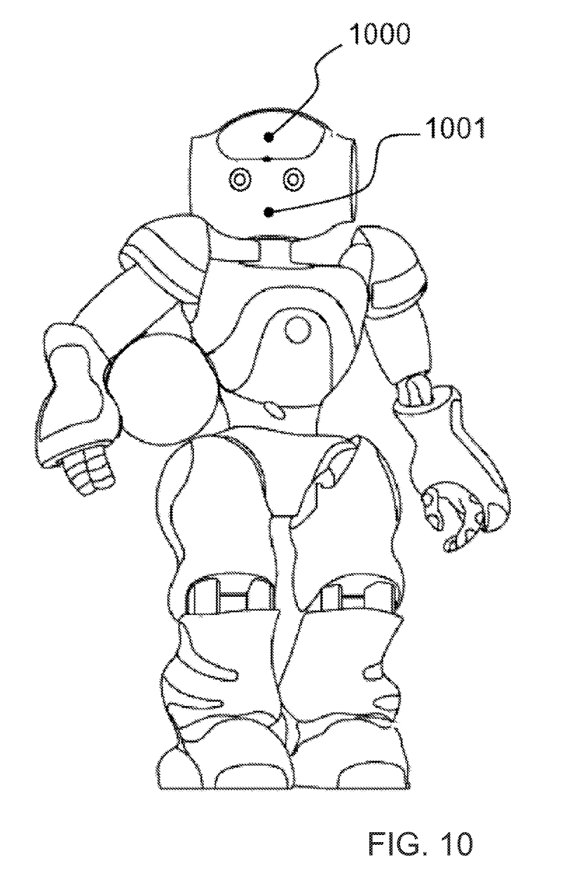

FIG. 10 shows a humanoid robot.

In the description, the invention is described using the example of an implementation on a robot, and more particularly on a humanoid robot. However, the invention can be applied to any moving element. In particular, the invention can be applied to any type of vehicle, boat or aircraft.

The subject of the invention is notably a method for estimating the angular deviation of a robot relative to a reference direction. This relative angular deviation is defined as being the angle between said reference direction and the orientation of the robot at the moment of the estimation. The orientation of the robot at the moment of the estimation is also called the current direction. By way of example, the value of this angle is determined clockwise from the reference direction.

Advantageously, the estimations of the relative angular deviation of the robot can be used to control its movements precisely, notably in order to perform rotations about a fixed point at a given angle or to perform a movement in a straight line in a given direction. Moreover, the method allows estimation of an absolute position for the robot.

FIG. 1 schematically illustrates the steps of a method for estimating the angular deviation of the orientation of a robot relative to a reference direction, said reference direction being associated with an image that is called the reference image in the remainder of the description.

First, a course value to be attained, called target course, is determined 100. By way of example, this target course value corresponds to an angle when the angular deviation is estimated in a two-dimensional coordinate system or else to a set of two angles corresponding, by way of example, to a latitude and to a longitude when the angular deviation is estimated in a three-dimensional coordinate system. In one embodiment and in the case of a humanoid robot, the target course can be chosen as being the orientation of the robot, said orientation corresponding, by way of example, to a vector that is perpendicular to the chest of the robot, passing through its center and directed toward the front.

A reference image is then acquired 101. The reference image can be obtained using an image sensor onboard the robot. This reference image is representative of the reference direction in relation to which the relative angular deviation of the robot is estimated by the method. In a preferred embodiment, the reference image is an image acquired when the image sensor is positioned in the reference direction.

A current image is duly acquired 102 at a given instant called the current instant. By way of example, this current image corresponds an image acquired from an image sensor onboard the robot at the current instant. In the case of a humanoid robot, this image sensor may be situated on the head, said head being able to be fixed or moving in relation to the body of the robot.

A set of points of interest is then identified 103 in the reference image and in the current image.

For that purpose, a method for detecting points of interest is used, such a method being denoted by the word detector in the remainder of the description. Furthermore, a point in an image is called a point of interest when it has features allowing it to be identified in a plurality of images resulting from different shots. In practice, a point of interest corresponds to an area of several pixels that is identified by a central pixel and a scale. By way of example, a point of interest can correspond to an area of a few pixels having a high level of contrast and corresponding to a cupboard corner.

When a point of interest has been identified by the detector, a descriptor can be associated therewith. A descriptor is an identifier for the point of interest that is usually represented in binary form. Descriptors notably allow identified points of interest to be compared from one image to the other. By way of example, a descriptor corresponds to a binary vector.

The descriptors of the reference image can be grouped into an index 103 called the reference index.

As for the reference image, points of interest are identified by a detector for this current image, a descriptor then being associated with each of these points.

Once the points of interest have been identified and characterized 103, a matching step 104 for the points of interest is implemented. This step 104 implements the search, for each of the identified points of interest in the current image, for at least one point of interest corresponding thereto in the reference image. For that purpose, the descriptors of the points of interest in the current image can be compared with the descriptors stored in the reference index.

In order to make this comparison, various techniques can be used, such as the technique denoted by the acronym KDTree, for example. The KDTree technique allows rapid comparison of a given vector with a precomputed index. In this case, for each identified point of interest in the current image, the two closest neighbors are selected. For a point of interest in the current image, the closest neighbors are points of interest in the reference image for which the difference between their descriptors and the descriptor of a point of interest in the current image is minimized. Next, if the distance to the closest neighbor is significantly shorter than the distance to the second neighbor, the closest neighbor is considered to be matched to the point of interest in the current image. This method allows some of the erroneous pairs of points to be eliminated. This is because if two different points of interest in the current image have close descriptors, the points of interest in the reference image that will be compared therewith will have close distances. This technique therefore makes it possible to reduce the number of identified matches, but likewise makes it possible to prevent too many points of interest in the current image from being badly matched.

A step 105 then has the aim of estimating the angular deviation relative to the reference direction. For that purpose, the pairs of points of interest that have been identified in the preceding step are analyzed. An example of comparison of two pairs of points of interest is provided later on in the description.

In one embodiment, the angular deviation is determined along the three axes X, Y, Z of an orthonormal reference frame that is fixed in relation to the robot. For that purpose, two pairs of points can be used. In order to implement the computations, it is assumed that the points of interest are situated at an infinite distance from the robot.

It can likewise be assumed that the robot turns on the spot. This is because a rotation about the Z axis translates into movement of the points from left to right, about the Y axis into movement from top to bottom (which can be seen with a single point) and about the X axis into rotation about the center of the image (which requires two points in order to perform the computation).

Once the angular deviation has been estimated, a check is performed 107 to ensure that the quality of the estimation is sufficient. In one embodiment, the quality is considered to be sufficient when the number of pairs of matched points of interest exceeds a predefined threshold value. If this is not the case, the quality of the estimation is considered to be insufficient and a new reference image is acquired 120 in order to continue the estimations. If this is the case, the quality is considered to be sufficient and a new current image is acquired 121 so as to follow the development of the angular deviation over the course of time.

As for the refresh rate of the current image 121, this needs to be chosen according to the navigation environment and the speed of the robot. The refresh rate of the current image can be adapted according to the estimated mean distance between the points of interest. The closest the points of interest are to one another, the higher the refresh rate. Thus, when the robot moves toward a wall, the refresh rate is increased.

One of the fundamental advantages of the invention is that computation of the deviation requires a single image representing the reference direction.

In one embodiment, the reference image can be updated by refreshing. In this case, the refresh rate of the reference image can be adapted in the course of operation and not fixed a priori. The refresh rate can be updated according to the quality of the visual points of reference and can be adapted automatically in order to preserve a minimum quality.

An example of a criterion allowing refreshing of the reference image to be initiated is estimation of the quality of the match and renewal of the reference image only if necessary, namely before the quality degrades. This quality can be estimated from the level of correct points obtained after the computation performed by the RANSAC algorithm. As soon as this level is too low, that is to say below a threshold that is fixed a priori, a new image is taken. The reference image is thus refreshed. The threshold can be chosen so that the preceding image is still valid, so as never to lose the reference image.

Depending on the environment, it is therefore possible for a single reference image to be sufficient for the whole of the trajectory followed by the moving element, for example in the case of a rotation. The reference frequency is therefore not fixed, since the reference image is updated not periodically but only when the quality of the match drops.

Moreover, the taking of an image in a reference direction allows the robot to be controlled in an unknown direction of the robot, owing to the flexibility of the points of reference. When the robot advances to an unknown area and the reference becomes obsolete, the automatic refreshing of the reference image allows an image to be retaken that is better suited to the new environment.

FIG. 2 provides a technical example of control of the trajectory of a robot using the method for estimating the angular drift.

First, the estimation of the angular deviation in relation to a reference direction is performed 200 as described above with reference to FIG. 1.

The aim is then to use the estimation of the angular deviation (step 107) in relation to a target (step 100) so as to control the trajectory of the robot.

Thus, a difference 201 between the target course and the estimated angular deviation is determined. By way of example, the difference 201 corresponds to an angle α that can be used as a command for controlling the trajectory of the robot.

If this difference is zero, this means that the target course has been reached 202. If this difference is not zero, the trajectory of the robot needs to be corrected 203 so that the target course is observed. The difference is 201 is then determined again so as to check whether the target course has been reached.

If the robot rotates on the spot, that is to say about a vertical axis passing through it, servocontrol can be provided as follows. First, the robot turns its head by an angle equal to α/2 relative to the position of the head when it is looking toward the front of the robot. A new reference image is then acquired. This new reference image will make it possible to guarantee that a maximum of points of interest will be able to be matched correctly during control of the rotation on the spot. The robot thus sets off with an angular deviation equivalent to −α/2 in relation to the new reference direction associated with this new reference image. It can then be commanded to reach an angular deviation relative to this new reference direction equal to α/2. For that purpose, it suffices to control the robot using an adapted-speed rotation command and to stop when this deviation value is reached.

Generally, in order to keep the reference image in the field of vision of the robot when it is moving, the estimated angular deviation can be used in order to control a movement of the head and to acquire a reference image so that a minimum number of points of interest can be matched.

When the robot moves in a straight line, the aim is to maintain a zero angular deviation in relation to the target course. For that purpose, the robot turns its head in the direction corresponding to the target course so as to acquire a reference image. Next, the movement of the robot is controlled using translation and/or rotation speed commands so as to maintain a zero angular deviation.

It is possible to maintain the position of the head in the direction of the target course while the body of the robot moves. This is because since the position of the head of the robot in relation to its body is known, the course of the robot can be deduced directly.

Advantageously, the method works even if all of the points of interest identified in the reference image do not remain visible to the sensor providing the current images. This is because two correctly matched pairs are sufficient in theory to estimate the angular deviation. However, the higher the number of correct pairs, the better the estimation of the angular deviation.

Still in the case of movement in a straight line, the odometry of the robot can be used to estimate the distance covered and to determine when the robot needs to stop. This is because this is more reliable than using a position estimation because in reality the points of interest are not positioned at infinity. The more the robot approaches the points of interest, the more the distances between them are expanded, which is not taken into account by the model. To compensate for this effect, the quality of the model is monitored 106 over the course of time: as soon as it lowers significantly, the reference image is renewed, which allows the assumption of the points at infinity to be revalidated.

The use of the method for estimating the angular deviation of a robot relative to a reference direction makes it possible to avoid the estimation errors that are characteristic of odometry. Advantageously, only speed commands determined according to the estimated angular deviation can be used.

It appears that a reference direction is used for the head in the case of rotation on the spot and rotation. The body of the robot must likewise follow a target direction that is the same as the head in the case of a translation, and different in the case of a rotation.

When a humanoid robot performs a translation, the reference direction and the orientation of the head can be the same. The head and the body of the robot are then servocontrolled in order to follow this direction.

In the case of rotation and if a corresponds to the angle of the rotation to be performed, the reference direction for the head is then α/2 in relation to the departure position, whereas the reference direction for the body is a in relation to the departure position. During the rotation, the head is maintained in its reference direction in order to keep the same image during a rotation as far as 180°, and the body is servocontrolled in order to align itself with the direction α. In relation to the head, the body is thus in the direction −α/2, at the departure and in the direction α/2 on arrival.

FIG. 3 provides an example of an image in which points of interest have been detected. In this example, a descriptor that is sensitive to areas of high contrast and to corners of the objects has been used.

Within the context of the method according to the invention, the detector must be chosen so that the same points of interest can be found from one image to the other. It must therefore be robust in the face of modifications resulting notably from the movements of the robot. An example of modifications corresponds to the application of a scale factor from one shot to the other when the robot is moving, for example when the robot moves in the direction of the reference image. A fuzzy effect resulting from a shot taken when the robot is moving can also be introduced. A change of luminosity can likewise occur between two shots. This can happen when the robot moves from a well lit area to a less well lit area.

In a preferred embodiment, the FAST (Features from Accelerated Segment Test) detector on the image pyramid is used. Advantageously, this detector has properties suited to its use within the context of the method according to the invention. A first property is that the extraction of points of interest is extremely rapid. It is thus possible to extract hundreds of points in a few milliseconds on a low-cost computation platform. The extraction of a large number of points of interest improves the robustness of the method in the event of obstruction of the points. Another property of the FAST detector is that it is robust in the event of a fuzzy shot and in the event of a change of luminosity. This is particularly useful when the method for estimating the angular drift is used during movement.

It should be noted that the FAST detector, when used alone, is not robust in the face of scale changes. This problem is solved by the construction of an image pyramid, that is to say a multiresolution representation of the image.

It is likewise possible to use other detectors from the prior art, such as the Harris detector, SURF (Speeded Up Robust Features) detectors and the SIFT (Scale Invariant Feature Transform) detector.

For each significant point identified by the detector, a descriptor is determined. The type of descriptor chosen to implement the method for estimation must allow effective matching of the points identified on two images. The match is considered to be effective when it allows the descriptors of the points of interest identified on two images to be compared and pairs to be identified, a pair corresponding to two identical points in two different images that is acquired in one and the same navigation environment.

In a preferred embodiment, the descriptor is an ORB (Oriented Fast and Rotated BRIEF) descriptor. This descriptor is generated by comparing two hundred and fifty six pairs of pixels in the area defined by the detector, and deducing a vector of two hundred and fifty six bits therefrom. Advantageously, the determination of an ORB descriptor is rapid to compute because the latter is determined by means of simple pixel comparison. Moreover, it is very rapid to compare two descriptors. This is because a descriptor corresponds to a binary vector. It is then possible to compare it in twos by using simple tools such as the Hamming distance, for example. Another advantage of the ORB descriptor is that it is robust when it is applied to fuzzy images and/or in the presence of changes of luminosity.

However, the method for estimating the relative angular deviation is not limited to the use of ORB descriptors. Other descriptors such as SIFT and SURF descriptors can be used.

FIG. 4 shows a pair of matched points and illustrates the way in which an angular deviation can be determined from two images.

In this example, two images 400, 401 are shown schematically. The first image 400 is a reference image comprising two points of interest 402, 403. The second image 401 is a current image likewise comprising two points of interest 405, 406. These different points of interest have been matched (step 104). Thus, a first pair is made up of the points 402 and 405 and a second pair is made up of the points 403 and 406.

The angular deviation (step 105) can be determined as follows. The aim is firstly to obtain the angular difference from measurements of the pixel differences between the two pairs of points. It is assumed that the two pairs of points have been matched correctly and that the movement of the robot between the two shots results solely from rotations, that is to say that the real movement is a pure rotation or else the points are positioned at infinity.

The rotation along the X axis is denoted wₓ and can be expressed in radians using the following expression:

$${w}_{x} = arg ( \frac{{z}_{1}^{′} - {z}_{2}^{′}}{z 1 - {z}_{2}} )$$

in which:
z₁ and z′₁ are complex numbers corresponding to the coordinates of the first pair of points of interest 402, 405 that are situated in the reference image 400 and the current image 401, respectively;
z₂ and z′₂ are complex numbers corresponding to the coordinates of the second pair of points of interest 403, 406 that are situated in the reference image 400 and in the current image 401, respectively;
arg( ) represents the function determining the argument of a complex number.

A quantity o is then determined using the following expression:

o=z′₁−z₁×e^{iθ}

The center of the image is denoted c. d is a complex number such that the real part corresponds to the deviation along the X axis and the imaginary part corresponds to the deviation along the Y axis. d can therefore be expressed as follows:

d=o−(1−e^{iw}^{ₓ})×c

The horizontal angular aperture of the camera is denoted oₕ and the vertical angular aperture is denoted oᵥ. iₕ denotes the width of the image and iᵥ denotes the height in pixels. The rotations w_{y} and wz along the X, Y and Z axes can be determined using the following expressions:

$${w}_{y} = {d}_{y} \frac{{o}_{v}}{{i}_{v}}$$

$${w}_{z} = - {d}_{x} \frac{{o}_{h}}{{i}_{h}}$$

However, it is possible that the assumptions above will not be verified in practice. This is because couples of points can be matched when they should not be. These bad matches can be due to the appearance of new points that were invisible in the reference image following a parallax phenomenon for example. These bad matches can likewise be the result of imperfect precision of the descriptors used or of imprecisions about the position of the points of interest. They can also be due to objects situated too close to the robot and for which the movement from one shot to the other translates in complex fashion. Objects that are moving can likewise cause bad matches.

In the description, the set made up of a point of interest in the reference image and of a point of interest in the current image being matched thereto but in reality corresponding to another point is denoted in the remainder of the description by the expression incoherent pair. By contrast, a pair is called coherent when the points of interest have been matched correctly.

In order to extract the coherent pairs from the set of pairs of points identified in step 106, the following technique can be used. Considering that the set of identified pairs contains at least one coherent pair and that the coherent pairs are such that a model computed on one of them will provide good results for all the other coherent pairs and bad results with the incoherent pairs. By contrast, a model computed on incoherent pairs will provide good results only for very few pairs of points that correspond at random. This principle is implemented notably by the RANSAC (RANdom Sample Consensus) algorithm. It allows the model that provides good results for a maximum of points to be found among a set of data points. Within the context of the method according to the invention, the model may notably be implemented by virtue of the equations provided above. The qualification of the results then hinges on the determination of the distance between the points predicted by the model from the points of interest in the reference image and the matched points in the current image.

Advantageously, the use of the RANSAC technique requires few computational resources because the processing operations are performed on a minimum number of points, for example on two pairs of points.

FIG. 5 provides an example of a result that can be obtained by applying a technique for identifying coherent pairs such as RANSAC.

A reference image 530 and the current image 520 are shown, as well as coherent pairs 500 to 508 and incoherent pairs 509 to 513. The robot has advanced between the two images. It appears that the incoherent pairs correspond to a bad match and that the coherent pairs show an overall deviation from left to right.

FIG. 6 shows a simplified illustration of a method for estimating the absolute angular position of a moving element.

The aim of the method described below is to estimate the absolute angular position of a robot. In contrast to the method of estimation described above, this method makes it possible to determine the orientation of the robot no longer in relation to the target course associated with a given reference image but rather in absolute fashion in a navigation space, that is to say in the movement space of the robot. This method likewise makes it possible to control the movement of the robot so as to reach an absolute angular position, notably when the robot turns on the spot.

The method for estimating the absolute angular position comprises a learning phase 600, a phase of choosing a reference image 601 from a plurality of candidate images and a phase of estimation of the angular position 602.

In a preferred embodiment, the phase of estimation of the angular position 602 resumes the steps of the method for estimating the relative angular deviation as described above.

FIG. 7 schematically illustrates the learning phase of the method for estimating the absolute angular position.

The learning phase firstly consists in capturing reference images 700 that are representative of the navigation space.

By way of example, an onboard image sensor can be controlled to perform a rotational movement of three hundred and sixty radians about the robot, namely in a horizontal plane.

The set of images taken during this learning phase is called the panorama in the remainder of the description.

By way of example, a wide-angle or panoramic image sensor can be used for this purpose. However, it should be noted that this type of sensor requires special lenses and that these deform the image. Moreover, they need to be placed at the top of the robot so as not to be disturbed by the robot itself.

To overcome these limitations, it is possible to use an image sensor having a shot angle that is more limited than those of the sensors described above.

In the case of a humanoid robot, the image sensor can be integrated into its head, which is adapted to be able to turn through three hundred and sixty radians. The images making up the panorama will be acquired over the whole required field by benefiting from the capability of the robot to turn its head and by implementing controlled rotation of the head, for example by applying the method for estimating the relative angular deviation.

Alternatively, the movements of the head can be replaced by the robot rotating on the spot. This can be useful notably when the head of the robot cannot turn through three hundred and sixty radians.

The reference images are acquired so that they partially overlap in twos. By way of example, two neighboring reference images in the panorama can overlap by half. In other words, these two images have one half-image in common in this case. This feature implies that a given reference image potentially has one or more points of interest in common one or more other reference images. Advantageously, the larger the areas of overlap, the more reliable the estimation.

For each reference image of the panorama, data being associated with them can be extracted and/or stored 701. By way of example, these data correspond to the points of interest and to the descriptors thereof, to the angular position of the reference images in relation to the initial position of the robot. The initial angular position of the robot can in fact serve as a reference. The reference images making up the panorama can be stored in a memory that is internal to the vehicle.

The reference images making up the panorama are then compared with one another 702. For that purpose, the points of interest extracted from the various images of the panorama are matched as described above. By way of example, the result of these comparisons can be stored in a matrix called a confusion matrix. This matrix is adapted so that each of its boxes comprises an integer equal to the number of matched points for two images of the panorama that have been compared. It is then possible to check what the level of similarity is between the images of the panorama.

The recording of the images of the panorama in a nonvolatile memory allows the random access memory of RAM type to be freed, for example. For rapid access, only the descriptors of the points of interest can be maintained in the random access memory. Moreover, storage of the images of the panorama in a nonvolatile memory allows a given panorama to be preserved permanently even after the robot is restarted.

FIG. 8 illustrates a way of choosing a reference image in a panorama and how the absolute angular position of the robot can be estimated.

After the learning phase, the absolute angular position of the robot can be estimated from the current image and from the odometry of the robot.

First, a current image is acquired 800.

Next, the current angular position of the robot is estimated (step 801) from the estimation of preceding angular position and the measurement of the movement by odometry. This estimation is not necessarily precise but allows initiation of the search for the best reference image that will allow the most precise possible estimation of the absolute position of the robot.

That image of the panorama that is associated with the angular position that is considered to be closest to the estimated angular position 801 is selected as a candidate reference image and its points of interest are matched to the points of interest in the current image (step 802).

A test 804 is then applied, said test having the function of comparing the number of pairs identified in step 802 with a number of pairs obtained in the preceding iteration, that is to say with another candidate reference image that has previously been selected if need be.

If the number of pairs identified in step 802 corresponds to a percentage less than or equal to a predefined value P, a reference image in the panorama that is a neighbor to the reference image used for this match is duly selected 805 as the candidate reference image. By way of example, P=30%. This new candidate reference image is chosen in the panorama so that there is more and more movement away, from one iteration to the other, from the image of the panorama initially selected by the method. Step 802 is then applied again.

If the result of the test 804 gives a number of pairs corresponding to a percentage above the predefined value P, the candidate reference image is considered to be satisfactory and is called the image I.

Once a candidate reference image I judged to be satisfactory has been found, the current image is compared 806 with the image I_{g} situated to the left of I in the panorama.

If the number of matched points of interest is greater than for the image I 807, then the new candidate image is the image I_{g} 808, or I=I_{g}.

If the number of matched points of interest is lower with the image I_{g} than with the image I, the current image is compared 809 with the image I_{d} situated to the right of I in the panorama.

If the number of matched points of interest is greater than for the reference image I 10, then the new candidate image is the image I_{d} 811, or I=I_{d}.

Once a reference image I has been selected, the absolute angular position is determined 812 by using the method for estimating the relative angular deviation described above by taking the current image and the reference image I selected in the panorama as inputs. This method estimates an angular difference in relation to an initial angular position. The absolute position can therefore be determined unambiguously because the initial angular position is associated with the reference image I and can be expressed in a point of reference that is fixed in relation to the navigation environment. The angular difference allows the absolute position of the robot to be deduced from the initial angular position.

FIG. 9 illustrates a way of controlling the rotational movements of the robot using the estimation of absolute angular position.

For that purpose, the estimation of the absolute position 900 is performed as described above (FIG. 8).

Next, the parameters allowing control of the movement of the robot are determined 901 in the usual manner in order to reach a previously chosen destination.

That image of the panorama that is associated with the course to be taken in order to implement the movement is selected 902.

The onboard image sensor is directed 903 in the direction of the course mentioned above so as to acquire the current images. If the sensor is mounted on the moving head of a humanoid robot, it is the head that makes this movement.

So long as points in the current image can be matched to points in the target image, the movement of the robot is implemented 904 with control of the angular drift. If the control of the movement through compensation for the angular drift is no longer effective, the movement can be controlled using the odometry of the robot.

FIG. 10 shows a humanoid robot that can implement the various techniques for estimating the angular drift, for determining the relative and absolute angular positions and for controlling movement as described above. The example chosen for this figure is an NAO (registered trademark) robot from the Aldebaran Robotics company. The robot comprises two sensors 1000, 1001 mounted on a head that can perform a circular movement through three hundred and sixty radians.

The head allows the robot to be provided with sensory and expressive capabilities that are useful for implementing the present invention.

By way of example, the robot comprises two 640×480 CMOS cameras that are capable of capturing up to thirty images per second, for example cameras in which the sensor is of the Omnivision™ brand referenced 0V7670 (⅙th-inch CMOS sensor: 3.6 μm pixels). The first camera 1000, placed at the forehead, is pointed toward its horizon, while the second 1001, placed at the mouth, examines its immediate environment. The software allows photographs of what the robot sees and the video stream to be acquired. In this example, the first camera 1000 can be used to acquire the current images and the reference images for implementing the methods for estimating the relative and absolute angular positions of the robot and for implementing the methods for controlling movement that are described above.

In the description, these methods have been described within the context of implementation on a robot, and more particularly on a humanoid robot. However, the invention can be applied for determining the angular position of any moving element. In particular, the invention can be applied to any type of vehicle, boat or aircraft.

By way of example, the invention can be applied for an automobile comprising a GPS (Global Positioning System) receiver that has been adapted to implementing the invention. Advantageously, the estimations of angular drift and/or of absolute angular position allow correction of GPS measurements, notably when an excessively small number of satellites is visible to said receiver.

1. A method for estimating the angular deviation of a moving element relative to a reference direction, the method comprising the following steps:
acquisition of a reference image that is representative of a reference direction of the moving element;
acquisition of a current image that is representative of the current direction of the moving element;
identification of points of interest in the reference image and in the current image;
determination of at least two pairs of points of interest, one pair being made up of a point of interest in the current image and of a point of interest corresponding thereto in the reference image;
determination of the angular deviation between the current direction and the reference direction of the moving element by using the at least two pairs of points identified in the preceding step.

2. The method as claimed in claim 1, in which the points of interest are associated with descriptors corresponding to binary vectors, the step of determination of the pairs being implemented by means of comparison of these vectors in twos, a couple of points of interest being identified when the two vectors of two points of interest are considered to be closest in relation to other candidate vectors associated with other points of interest.

3. The method as claimed in claim 1, in which the angular deviation is determined along the three axes X, Y, Z of an orthonormal reference frame that is fixed in relation to the moving element.

4. The method as claimed in claim 1, comprising a step of verification of the quality of the estimation of the angular deviation, the quality being considered sufficient when the number of pairs of matched points of interest exceeds a predefined threshold value.

5. The method as claimed in claim 4, in which a new reference image is acquired when the quality is considered insufficient.

6. The method as claimed in claim 1, in which the refresh rate of the reference image is adapted according to the quality of the points of interest, said quality being estimated from the level of correct points of interest and the reference image being updated as soon as this level is below a predefined threshold value.

7. The method as claimed in claim 1, in which the refresh rate of the current image is adapted according to the estimated mean distance between the points of interest identified in the current image, the refresh rate being increased when the points of interest approach one another.

8. The method as claimed in claim 1, in which the reference direction corresponds to a target course that the moving element needs to follow in order to move, commands for controlling the movement of the moving element being determined and applied so that the angular deviation estimated by the method minimized.

9. The method as claimed in claim 1, in which the reference image is chosen so that it remains at least partially in the field of vision of a sensor responsible for acquiring the current image so that a predefined minimum number of points of interest can be matched.

10. The method as claimed in claim 1, in which the initially estimated angular deviation is a radians in relation to a target course that the moving element needs to follow in order to move, the reference direction then corresponding to the target course to which an angular deviation of −α/2 radians is added, commands for controlling the movement of the moving element being determined and applied so that the angular deviation estimated subsequently is as close as possible to +α/2 radians.

11. The method as claimed in claim 1, in which the reference image is obtained by an image sensor that is onboard the moving element and directed in the reference direction at the moment of the shot.

12. A method for estimating the angular position of a moving element in a point of reference that is fixed in relation to a navigation space, the method comprising the following steps:
acquisition of a panorama that is made up of a plurality of images covering the navigation space, one image of the panorama being representative of a direction leaving the moving element;
estimation of the angular position of the moving object by odometry;
selection of a reference image from the images of the panorama, said image corresponding to the angular position estimated in the preceding step;
refined estimation of the angular position of the moving element, said angular position being deduced from an angular drift estimated by application of the method as claimed in claim 1 with the selected reference image.

13. The method as claimed in claim 12, in which the moving element is a robot of humanoid type.

14. The method as claimed in claim 12, in which the moving element is an automobile.

15. A humanoid robot comprising means adapted to implementing the method as claimed in claim 1.

16. A computer program having instructions for executing the method as claimed in claim 1 when the program is executed by a data processing module.
